(19) United States
(12) Patent Application Publication
(10) Pub. No.: US 2026/0178490 A1
(43) Pub. Date: Jun. 25, 2026

(54) EXTENDING TEMPORAL COHERENCY WITHIN MSOC TO IMPROVE CACHE REPLACEMENT POLICIES FOR MSOC

(71) Applicant: Mercedes-Benz Group AG, Stuttgart (DE)

(72) Inventor: Shweta Jain, Sunnyvale, CA (US)

(21) Appl. No.: 18/990,268

(22) Filed: Dec. 20, 2024

(51) Int. Cl. G06F 12/0802

(52) U.S. Cl. CPC G06F 12/0802; G06F 2212/60

(57) ABSTRACT

An electronic control unit in which a plurality of workloads are identified from execution of a runtime application, where each identified workload is associated with a set of cache lines of a cache resource. A priority designation of the set of cache lines is determined based at least in part on a usage of the set of cache lines during an upcoming time interval. In examples, the usage is based at least in part on memory access operations that are expected to be performed by the plurality of workloads during the upcoming time interval.

### TECHNICAL BACKGROUND

Examples relate to cache replacement policies for electronic control units, and more particularly, extending temporal coherency to improve cache replacement policies.

### BACKGROUND

Caches are small, fast, memory units used to store frequently accessed data by the CPU. The cache memory hides the latency of accessing the data from the slower main memory by reducing the number of accesses by the CPU to the main memory. When the cache is full, and a new data request has to be fetched from the main memory the cache controller evicts an existing cache line to accommodate the new request. This is known as cache line eviction and the cache controller uses different replacement policies to determine which cache line is to be replaced without negatively impacting the cache performance

In computing environments, a cache controller typically manages its cache resources using a cache replacement policy. Typically, the cache replacement policy is based on temporal locality—the premise being that a cache line that has been recently used will also be used in the near future. This approach has overhead, as it requires the cache controller to maintain a history of usage on all of the cache lines over a runtime of an executing application. To manage such overhead, a cache replacement policy can maintain a cache line history over a fixed interval of time and use this to make an eviction decision for that interval. Upon the interval ending, conventional approaches have provided that the cache replacement policy resets the cache line history, so that tracking of cache line usage is initiated at the start of each new interval. The cache controller repeats this process throughout the application runtime by resetting the history of cache lines at the beginning of new interval and tracking the usage again.

The commonly used replacement policies are Least Recently Used (LRU), Not Recently Used (NRU), Most Recently Used (MRU) etc. These replacement policies work on the principle of temporal locality (i.e.) a cache line that has been recently used will be also used in near future and should not be evicted. This requires the cache controller to maintain a history of usage on all the cache lines over the runtime of an application. Depending on the cache size and application runtime this can become prohibitively expensive to implement. Instead, the replacement policies maintain the cache line history over a fixed interval of time and use this to make an eviction decision for that interval. The cache controller repeats this process throughout the application runtime by resetting the history of cache lines at the beginning of new interval and tracking the usage again. The success of conventional approaches is dependent on the duration of time interval for which cache line history is tracked before being reset. A longer interval is preferred to provide more accurate cache line usage history, but it is offset by the hardware implementation cost of the same.

### SUMMARY

Examples provide an electronic control unit that develops a cache line replacement policy based on advanced knowledge of cache line usage during an upcoming interval.

In additional examples, a plurality of workloads are identified from execution of a runtime application, where each identified workload is associated with a set of cache lines of a cache resource. A priority designation is determined for the set of cache lines of each workload of the plurality of workloads, where the priority designation is determined based at least in part on a usage of the set of cache lines during an upcoming time interval. In some examples, the determination of the cache line usage is based at least in part on memory access operations that are expected to be performed by the plurality of workloads during the upcoming time interval.

Still further, examples include a vehicle control unit that includes a plurality of chiplets, including a first chaplet, where the first chiplet includes a main memory and cache resources. Control logic is provided with the first chiplet to maintain a reservation table in the main memory, where the control logic is configured to identify a plurality of workloads from the execution of the runtime application, and each identified workload is associated with a set of cache lines of a cache resource. For each identified workload, the control logic determines a priority designation for a corresponding set of cache lines based at least in part on a usage of the set of cache lines during an upcoming time interval. The usage is based at least in part on memory access operations that are expected to be performed by the plurality of workloads during the upcoming time interval.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example computing system 100 in which embodiments described herein may be implemented, in accordance with examples described herein.

FIG. 2 illustrates an electronic control unit (ECU) for an active computing environment, according to one or more embodiments.

FIG. 3 is a block diagram illustrating a vehicle control unit, according to one or more embodiments.

FIG. 4 illustrates an example method for implementing a cache line replacement policy based on advanced knowledge of cache line usage information, according to one or more embodiments.

### DETAILED DESCRIPTION

Examples as described include an electronic control unit (“ECU”) having processing resources (e.g., chiplets) to control and/or perform functions in a dynamic, active and data intense computing environment. An example ECU can be implemented as a system on chip (SoC), multiple systems of chip (mSoC), or other types of processing architectures for handling high volumes of data. An example ECU can process a high volume of data in a highly dynamic computing environment (e.g., a moving vehicle in traffic). To reduce latency, an example ECU as described leverages the use of cache memory to store frequently accessed data. Examples as described provide for an ECU that optimizes its cache resources by implementing a cache replacement policy that selectively replaces cache lines based on the known usage of the cache line during an upcoming time interval.

Examples include an ECU for developing a cache replacement policy based on advanced knowledge of cache line usage information. Further, an example includes an ECU for extending temporal coherency within an ECU (e.g., system on chip (SoC) or multiple systems on chip (mSoC) to implement an improved cache replacement policy.

While examples can be implemented in numerous types of computing environments, specific examples are provided in context of robotics and autonomous vehicles. Autonomous vehicles, for example, consume large amounts of data in environments that require real-time or even near instantaneous responsiveness. Examples as described enable an ECU to optimize its use of cache resources, through implementation of cache replacement policies that accurately anticipate which cache lines are used during the execution of a portion of an application. Furthermore, the cache line replacement policy is continuously or repeatedly updated as the runtime application executes, so that the cache replacement policy remains accurate and specifically tailored for the portion of the runtime application that is presently being executed.

In contrast to conventional approaches, an example ECU determines cache line information for a portion of a runtime application, in advance of the portion of the application being executed. The cache line information identifies cache lines that are to be used in the execution of the application. Each cache line is identified by a cache line identifier. Further, each identified cache line is associated with usage data that indicates an extent to which the portion of the application utilizes the cache line during execution of the portion of the application. In examples, an example ECU is operable to identify a plurality of workloads from execution of a runtime application, where each identified workload is associated with a set of cache lines of a cache resource. A priority designation is determined for the set of cache lines of each workload of the plurality of workloads, where the priority designation is determined based at least in part on an expected usage of the set of cache lines during an upcoming time interval. In examples, the expected usage can be determined from memory access operations that are expected to be performed by the plurality of workloads during an upcoming time interval.

The ECU 100 implements a cache line replacement policy for executing the portion of the runtime application based on the determined cache line information, such that the selection of cache lines for eviction is based at least in part on the extent the cache line is to be used during the execution of the portion of the application.

In additional examples, cache line information is determined for a portion of an application in advance of the portion of the application being executed. The cache line information can include cache line identifiers, and usage data for the individual cache lines during the execution of a portion of an application, where the usage data indicates an extent to which the portion of the application utilizes the cache line.

In examples, the usage data that is determined for individual cache lines includes a frequency in which individual cache lines are used during the execution of a portion of an application. In additional examples, the cache line usage indicates a time or interval between when the cache line is utilized during execution of the portion of the application.

In examples, a cache line replacement policy is determined that prioritizes cache lines based on their respective usage. The cache line replacement policy can provide for cache lines that have low (or lower) priority to be replaced before cache lines with high (or higher) priority.

Further, in examples, the cache line replacement policy is dynamic, by updates that repeatedly or continuously made with further execution of the application. In this way, the cache line replacement policy remains accurate and specifically tailored for the portion of the application that is presently being executed.

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer programs, or a computer usable carrier medium capable of carrying such a program.

### Example Computing System

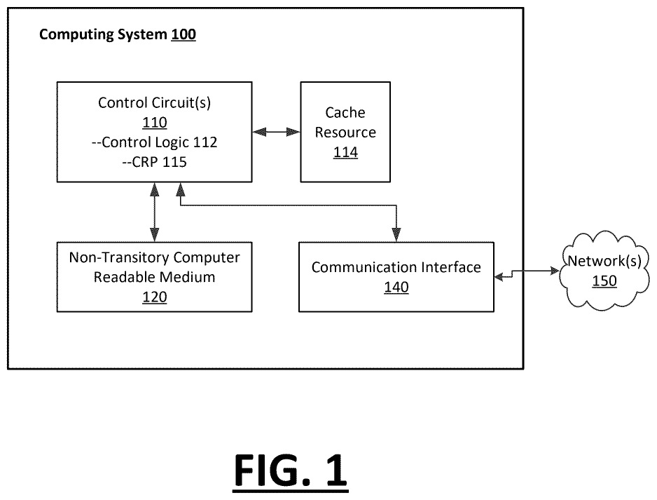

FIG. 1 is a block diagram depicting an example computing system 100 in which embodiments described herein may be implemented, in accordance with examples described herein. In an embodiment, the computing system 100 can include one or more control circuits 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), systems on chip (SoCs), multiple systems on chip (mSoC), or any other control circuit. In some implementations, the control circuit(s) 110 and/or computing system 100 may be part of, or may form, an electronic control unit (“ECU”) for use in a dynamic, data intensive computer sensing environment, such as in a vehicle controller for autonomous operation. For example, the computing system 100 can be embedded or otherwise disposed in a vehicle (e.g., a Mercedes-Benz® car, truck, or van).

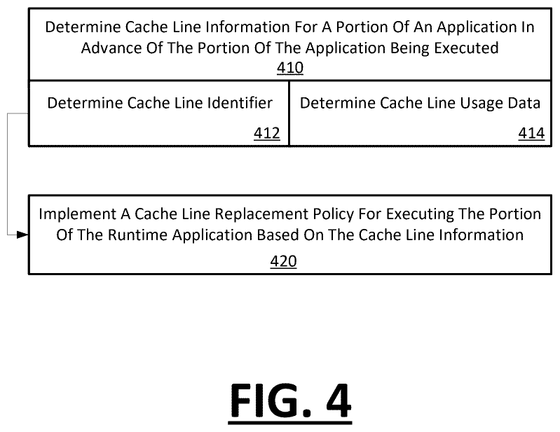

In an embodiment, the control circuit(s) 110 are programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, for example, a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions, such as instructions to perform an example method such as described with FIG. 4.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 110 to perform one or more functional tasks. The modules and computer-readable/executable instructions may be described as performing various operations or tasks when the control circuit(s) 110 or other hardware components execute the modules or computer-readable instructions.

In further embodiments, the computing system 100 can include a communication interface 140 that enables communications over one or more networks 150 to transmit and receive data. In various examples, the computing system 100 can communicate, over one or more networks 150 and using the communication interface 140, with other vehicles (e.g., fleet vehicles), satellite systems (e.g., navigation satellites), cellular towers, or other types of communication mediums. The communication interface 140 may include any circuits, components, software, etc, for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

As an example embodiment, the control circuit(s) 110 of the computing system 100 can include a SoC arrangement that facilitates the various methods and techniques described throughout the present disclosure. In various examples, the SoC can include a set of chiplets, including a central chiplet comprising a shared memory in which a reservation table is utilized to execute various autonomous driving workloads in independent deterministic pipelines, as described herein.

The control circuit(s) 110 can execute one or more applications that are statically laid out (e.g., “SLO”). The control circuit(s) 110 utilize a statically pre-computed computation graph of the application's execution to determine information about the memory access operations that are to be performed when the application, or portion thereof, is executed. The SLO execution of applications enables every memory access operation and address to be determined prior to execution of a corresponding portion of the application.

In examples, control circuit(s) 110 implement control logic 112 to manage cache resources 114 of the control circuits 110 and/or computing system 100. The control circuit(s) 110 use a predetermined computation graph for the SLO execution of the application to determine cache line information for a portion of an application that is to execute at runtime. Based on the determined cache line information, the control circuit(s) 110 implement a cache line replacement policy 115 for a duration in which the portion of the application is executed. Further, in examples, the cache line replacement policy 115 is repeatedly or continuously updated, based on cache line information determined for subsequent of the executing application. In this way, the cache line replacement policy 115 is dynamically updated and specifically tailored for a portion of an application that is being presently executed.

In examples, cache line information includes usage data for individual cache lines that are to be used in the execution of a portion of a runtime application. The usage data can include data that indicates a frequency in which a particular cache line (or set of cache lines) is used during execution of the portion of the application. As an addition or variation, the usage data of individual cache lines can include information that indicates a time or interval between instances when the cache line is utilized during execution of the portion of the application.

In examples, the cache line replacement policy 115 is implemented by providing select cache lines with a priority designation based on their respective usage data. As the usage data is determined a priori to the execution of the portion of the application, the select designation of priority cache lines can accurately reflect those cache lines which will have greater usage during the runtime execution of the portion of application. In this way, the control logic 112 optimize cache utilization by accurately anticipating which cache lines will be most active when the portion of the application is executed.

In additional examples, the priority designation is implemented for select cache lines using a set of cache management data fields in a set of task execution instructions, where the set of cache management data fields selectively identify, based on usage data, individual cache lines as high priority. Those cache lines which are not designated as high priority can be designated or assumed as low priority. In variations, the priority designation can be trinary (e.g., high, low or intermediate priority), a ranking, or a score. In the case where certain cache lines are designated as high priority and others are low priority, the cache line replacement policy provides for replacing cache lines with the low priority designation before any cache lines with the high priority designation are replaced.

The control circuit(s) 110 can implement the cache line replacement policy 115 using a scheduler or mailbox program. Such programs can schedule workloads, and the cache line replacement policy 115 can be integrated or otherwise embedded with the entries of such scheduler or mailbox program.

### Electronic Control Unit

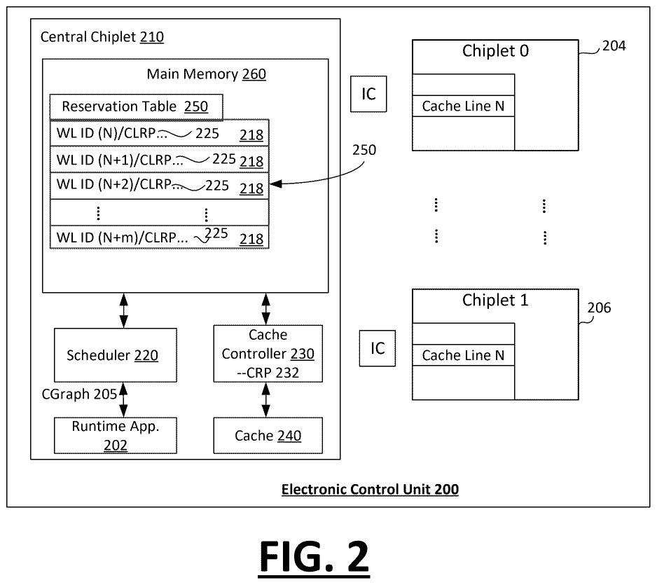

FIG. 2 illustrates an electronic control unit (ECU) for a system on chip (SoC) device, according to one or more embodiments. As shown, the ECU 200 includes a plurality of chiplets, including a central chiplet 210 and multiple compute chiplets 204, 206. The central chiplet 210 includes a main memory 260 and cache resources 240. The central chiplet 210 also includes logic represented by a scheduler 220, to identify workloads, representing tasks that are to be performed by an application 202 that is executed at runtime on the ECU 200. The application 202 can execute using output provided by another chiplet 204, 206 of the ECU 200. Alternatively, the application 202 can execute to provide output for one of the other chiplets 204, 206. In a typical SoC environment, the execution of the application 202 involves numerous data exchanges with other chiplets, with tasks being sequenced or dependent on other tasks (which may be performed by other chiplets). Further, while an example of FIG. 2 illustrates a simplified version of an SoC, the ECU 200 can execute multiple applications at one time on a given chiplet, as well as utilize any number of chiplets in conjunction with the central chiplet 210. The scheduler 220 and reservation table 250 are then used to sequence tasks performed by workload, as well as to manage dependencies amongst the various workloads, to ensure dependencies are resolved appropriately and in sequence. The tasks or workloads maintained in the reservation table 250 can be communicated to other chiplets as provided. Furthermore, other chiplets can monitor the reservation table 250 to determine when tasks for specific workloads are ready to be performed.

As shown by an example of FIG. 2, the application 202 is executed as a statically laid out application. As a statically laid out application, a compute graph 205 can be generated for portions of the runtime application in advance of those portions being executed. The scheduler 220 can process the computation graph 205 to determine cache line usage for every cache line prior to execution of a portion (e.g., workload) of the application 202.

Accordingly, in examples, as the application 202 executes, the scheduler 220 populates a reservation table 250 with workload entries 218, where each workload entry 218 corresponds to a portion of the runtime application 202 being executed. Each workload entry 218 can be implemented as a data structure (e.g., 64-bit data structure) having workload fields that identify and provide information about a corresponding workload. In at least some examples, the workload entry 218 reserves a set of bits (“priority designation field 225”) for designating a priority level of the corresponding workload. Based on implementation, the priority designation field 225 can be structured as a binary field (e.g., high priority/low priority), trinary field (e.g., high priority, mid priority, low priority) or multi-value field to designate the priority level of the cache lines referenced by individual workload entries, where the priority designation is based on the usage of the cache line.

In examples, the scheduler 220 determines that individual workloads are to perform specific cache line access. The determination can be an inference or correlation, based on the type/sub-types associated with the workload, as identified from the workload entry 218. The scheduler 220 can determine the priority designation field 225 for the cache line access of individual workloads, where the priority designation field 225 is based at least in part on (i) a frequency of the cache line access performed, and/or (ii) an interval of cache line usage. By way of example, the scheduler 220 determines the priority designation fields 225 using logic such as represented by the following table:

TABLE 1

| Frequency of Usage | Interval between Usage |
|---|---|
| High | Long (Mid High Priority) |
| High | Short (High Priority) |
| Low | Long (Low Priority) |
| Low | Short (Mid Low Priority) |

The priority designation field 225 can provide an annotation for cache line access performed with execution of the workload. The annotation can indicate whether the cache line access performed with execution of the workload meets a usage threshold, such as a frequency threshold. As an addition or variation, the annotation can indicate whether a cache line used in the execution of the workload satisfy a timing condition, such as an interval until the cache line access is performed, and/or an interval between when cache line access is frequently performed.

The scheduler 220 can communicate the workloads entries 218 of the reservation table 250 to a cache controller 230. The cache controller 230 can implement a cache line replacement policy 232 that is based at least in part on the annotation of the workload. The cache line replacement policy 232 can include, or is based on, the priority designation field of the cache line access performed when the workload entry is executed. Based on the cache line replacement policy 232, the cache controller 230 can prevent high priority cache lines from being evicted from a cache resource 240 of the ECU 200. Under the replacement policy, no high priority cache line is evicted before a low priority cache line. In a variation, under the cache replacement policy 232, the probability of a high priority cache line being evicted before a low priority cache line is substantially less than would otherwise be provided by a conventional temporal location-based policies (e.g., LRU).

Further, examples provide that as the application 202 is executed over time, the priority designations for the cache lines cm shift. The runtime application 202 can continuously execute during an operational interval. The scheduler 220 can repeatedly process the computation graph 205 for the statically laid out execution of the runtime application 202. The scheduler 220 can then repeatedly update the reservation table 250 with new workload entries 218, where each workload entry 218 identifies a workload corresponding to a portion of the application 202. The scheduler 220 uses the computation graph 205 for portions related to the individual workload entries to determine the priority designation field 225 for the cache lines used with each workload entry. In this way, the reservation table 250 is dynamically updated with continuous execution of the runtime application 202. As the reservation table 250 is updated, the priority designation fields 225 for the workload entries are also updated, reflecting changes to the policies relating to the cache line usage of the cache component 240. In this way, the cache line replacement policy 232 is dynamically updated for the cache 240.

### Vehicle Control Unit

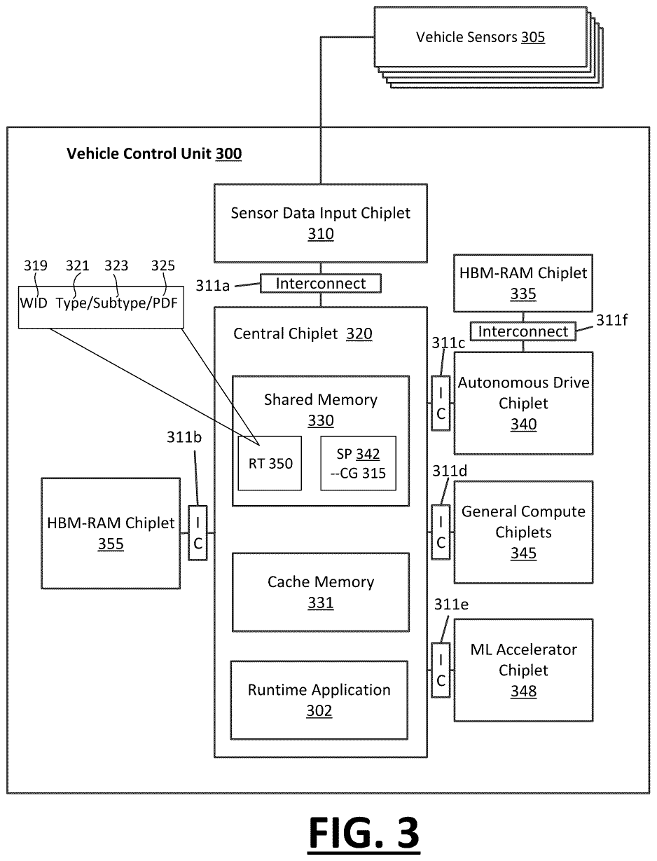

FIG. 3 is a block diagram illustrating a vehicle control unit 300, according to one or more embodiments. A vehicle control unit 300 provides an example of an electronic control unit, such as shown and described with an example of FIG. 2. With reference to FIG. 3, the vehicle control unit 300 can be implemented as a system on chip (SoC) or multiple systems on chip (mSoC) device, for purpose of controlling various types of vehicle operations, such as autonomous operation of vehicles. Based on implementation, the vehicle control unit 300 can include additional components, and the components of the vehicle control unit 300 can be arranged in various alternative configurations other than the example shown. Thus, the vehicle control unit 300 of FIG. 3 is described herein as an example arrangement for illustrative purposes and is not intended to limit the scope of the present disclosure in any manner.

The vehicle control unit 300 can include a set of chiplets, including a central chiplet 320 comprising a shared memory 330 and a set of workload chiplets, which in an example shown include autonomous drive chiplet 340, general compute chiplet 345, and master accelerator chiplet 348. The sensor data input chiplet 310 can generate workload entries for a reservation table 350 comprising identifiers for the sensor data (e.g., an identifier for each obtained image from various cameras of the vehicle's sensor system) and provide an address of the sensor data in the cache memory 331.

In various implementations, the shared memory 330 can store programs and instructions for performing vehicle control tasks. The shared memory 330 of the central chiplet 320 can further include a reservation table 350 that provides the various chiplets with the information needed (e.g., sensor data items and their locations in memory) for performing their individual tasks. The central chiplet 320 also includes the large cache memory 331, which supports invalidate and flush operations for stored data.

Accordingly, the reservation table 350 can include workload entries, each of which indicates a workload identifier that describes the workload to be performed, an address in the cache memory 331 and/or HBM-RAM of the location of raw or processed sensor data required for executing the workload, and any dependency information corresponding to dependencies that need to be resolved prior to executing the workload. In certain aspects, the dependencies can correspond to other workloads that need to be executed.

When workloads are completed by the chiplets, dependency information for additional workloads in the reservation table 350 can be updated to indicate so, and the additional workloads can become available for execution in the reservation table when no dependencies exist. In certain examples, the chiplets can monitor the reservation table 350 by way of a workload window and instruction pointer arrangement, in which each entry of the reservation table 350 is sequentially analyzed along the workload window by the workload processing chiplets. If a particular workload is ready for execution (e.g., all dependencies are resolved), the workload processing chiplets can execute the workload accordingly. When a workload is executed by a particular chiplet, the chiplet updates the dependency information of other workloads in the reservation table 350 to indicate that the workload has been completed. This can include changing a bitwise operator or binary value representing the workload (e.g., from 0 to 1) to indicate in the reservation table 348 that the workload has been completed. Accordingly, the dependency information for all workloads having dependency on the completed workload is updated accordingly.

Once the dependencies for a particular workload are resolved, the workload entry can be updated through execution of a scheduling program 342. When no dependencies exist for a particular workload as referenced in the reservation table 350, the workload can be executed in a respective pipeline by a corresponding workload processing chiplet. The workload entries can be distributed to the workload processing chiplets. The workload processing chiplets can monitor and update the reservation table 350 comprising workload entries. Further, the workload entries can include cache addresses of workload data for executing a respective workload, as well as dependency information that is to be resolved before executing the respective workload.

Referring to FIG. 3, a sensor data input chiplet 310 of the vehicle control unit 300 can receive sensor data from various vehicle sensors 305. The vehicle sensors 305 can include, for example, any combination of image sensors (e.g., single cameras, binocular cameras, fisheye lens cameras, etc.), LIDAR sensors, radar sensors, ultrasonic sensors, proximity sensors, and the like. The sensor data input chiplet 310 can automatically dump the received sensor data as it's received into a cache memory 331 of the central chiplet 320. The sensor data input chiplet 310 can also include an image signal processor (ISP) responsible for capturing, processing, and enhancing images taken from the various vehicle sensors 305. The ISP takes the raw image data and performs a series of complex image processing operations, such as color, contrast, and brightness correction, noise reduction, and image enhancement, to create a higher-quality image that is ready for further processing or analysis by the other chiplets of the vehicle control unit 300. The ISP may also include features such as auto-focus, image stabilization, and advanced scene recognition to further enhance the quality of the captured images. The ISP can then store the higher-quality images in the cache memory 331.

The sensor data input chiplet 310 can obtain sensor data from the vehicle sensors 305. The sensor data input chiplet 310 stores, or causes to be stored, sensor data (e.g., image data, LIDAR data, radar data, ultrasonic data, etc.) in the cache memory 331. The sensor data input chiplet 310 can generate an identifier for the sensor data (e.g., an identifier for each obtained image from various cameras of the vehicle's sensor system) and indicate an address of the sensor data in the cache memory. The identifier and address of the sensor data can be referenced in the reservation table 350 that includes workload identifiers, dependency information for each workload, and addresses of the necessary data to execute a particular workload. The reservation table 350 can be referenced by the workload processing chiplets to execute the workloads.

In some aspects, the sensor data input chiplet 310 publishes identifying information for each item of sensor data (e.g., images, point cloud maps, etc.) to a shared memory 330 of a central chiplet 320, which acts as a central mailbox for synchronizing workloads for the various chiplets. The identifying information can include details such as an address in the cache memory 331 where the data is stored, the type of sensor data, which sensor captured the data, and a timestamp of when the data was captured.

To communicate with the central chiplet 320, the sensor data input chiplet 310 transmits data through an interconnect 311a. Interconnects 311a-f each represent die-to-die (D2D) interfaces between the chiplets of the vehicle control unit 300. In some aspects, the interconnects include a high-bandwidth data path used for general data purposes to the cache memory 331 and a high-reliability data path to transmit functional safety and scheduler information to the shared memory 330. Depending on bandwidth requirements, an interconnect may include more than one die-to-die interface. For example, interconnect 311a can include two interfaces to support higher bandwidth communications between the sensor data input chiplet 310 and the central chiplet 320.

In one aspect, the interconnects 311a-f implement the Universal Chiplet Interconnect Express (UCIe) standard and communicate through an indirect mode to allow each of the chiplet host processors to access remote memory as if it were local memory. This is achieved by using a specialized Network on Chip (NoC) Network Interface Unit (NIU) (allows freedom of interferences between devices connected to the network) that provides hardware-level support for remote direct memory access (RDMA) operations. In UCIe indirect mode, the host processor sends requests to the NIU, which then accesses the remote memory and returns the data to the host processor. This approach allows for efficient and low-latency access to remote memory, which can be particularly useful in distributed computing and data-intensive applications. Additionally, UCIe indirect mode provides a high degree of flexibility, as it can be used with a wide range of different network topologies and protocols.

In various examples, the vehicle control unit 300 can include additional chiplets that can store, alter, or otherwise process the sensor data cached by the sensor data input chiplet 310. The system on chip 300 can include an autonomous drive chiplet 340 that can perform the perception, sensor fusion, trajectory prediction, and/or other autonomous driving algorithms of the autonomous vehicle. The autonomous drive chiplet 340 can be connected to a dedicated HBM-RAM chiplet 335 in which the autonomous drive chiplet 340 can publish all status information, variables, statistical information, and/or processed sensor data as processed by the autonomous drive chiplet 340.

In various examples, the vehicle control unit 300 can further include a machine-learning (ML) accelerator chiplet 340 that is specialized for accelerating AI workloads, such as image inferences or other sensor inferences using machine learning, in order to achieve high performance and low power consumption for these workloads. The ML accelerator chiplet 340 can include an engine designed to efficiently process graph-based data structures, which are commonly used in AI workloads, and a highly parallel processor, allowing for efficient processing of large volumes of data. The ML accelerator chiplet 340 can also include specialized hardware accelerators for common AI operations such as matrix multiplication and convolution as well as a memory hierarchy designed to optimize memory access for AI workloads, which often have complex memory access patterns.

The general compute chiplets 345 can provide general purpose computing for the vehicle control unit 300. For example, the general compute chiplets 345 can comprise high-powered central processing units and/or graphical processing units that can support the computing tasks of the central chiplet 320, autonomous drive chiplet 340, and/or the ML accelerator chiplet 348.

Cache miss and evictions from the cache memory 331 are sent by a high-bandwidth memory (HBM) RAM chiplet 355 connected to the central chiplet 320. The HBM-RAM chiplet 355 can include status information, variables, statistical information, and/or sensor data for all other chiplets. In certain examples, the information stored in the HBM-RAM chiplet 355 can be stored for a predetermined period of time (e.g., ten seconds) before deleting or otherwise flushing the data. For example, when a fault occurs on the autonomous vehicle, the information stored in the HBM-RAM chiplet 355 can include all information necessary to diagnose and resolve the fault. Cache memory 331 keeps fresh data available with low latency and less power required compared to accessing data from the HBM-RAM chiplet 355.

As provided herein, the shared memory 330 can house a mailbox architecture in which a reflex program comprising a suite of instructions is used to execute workloads by the central chiplet 320, general compute chiplets 345, and/or autonomous drive chiplet 340. In certain examples, the central chiplet 320 can further execute a functional safety (FuSa) program that operates to compare and verify output of respective pipelines to ensure consistency in the ML inference operations. In still further examples, the central chiplet 320 can execute a thermal management program to ensure that the various components of the vehicle control unit 300 operates within normal temperature ranges. Further description of the shared memory 330 in the context of out-of-order workload execution in independent deterministic pipelines is provided below with respect to FIG. 3.

In examples, the scheduler 342 identifies workload entries for the reservation table 350. Each workload entry 318 can include an identifier 319, a type field 321, one or more subtype fields 323, dependency information for the identified workload, state information that identifies a state of the workload, and additional information. The type/sub-types can be specific to a variety of attributes, such as a function type and a source input. Each workload entry 318 can also include one or more bits that are designated for a priority designation field 325. In examples, the priority designation field 325 can include a set of priority designation bits and/or a hint.

In examples, the scheduler 342 continuously schedules workloads with the reservation table 350, as dependencies are resolved. In example, each workload can be represented in the reservation table 350 as a 64-bit data structure, with the bit fields of the data structure being associated with workload identification, workload type and sub-type, and dependency information. The scheduler 342 can infer the specific cache line access performed by individual workloads that are listed in the reservation table 350 based on the type and subtype fields associated with the individual workloads. Additionally, the scheduler 342 can determine the workload access that is to occur for specific cache lines during an upcoming interval. For example, based on the type and sub-type of workload access that is to occur for specific cache lines, as well as future access by other workloads to the specific cache lines (as determined from the computation graph for the application 302), the priority designation field for those cache lines can be determined and made part of the cache replacement policy, at least for the upcoming time interval. In this way, the scheduler can determine the extent and nature of the cache line access (e.g., based on the type and subtype associated with the workloads), as well as the frequency and timing of use (e.g., based on the computation graph 315.

### Methodology

FIG. 4 illustrates an example method for implementing a cache line replacement policy based on advanced knowledge of cache line usage information, according to one or more embodiments. An example method of FIG. 4 can be implemented using examples such as described with FIG. 1 through FIG. 3. In the particular examples as described, reference is made to elements of FIG. 2 for purpose of illustrating a step or sub-step being described.

With reference to FIG. 4, an ECU 200 determines cache line information for a portion of an application, in advance of the portion of the application being executed (410). In examples, workload entries can be scheduled for performance in a reservation able 250, where execution of the workload entries are statically laid out. As execution of the workload entries is statically laid out, every memory access address and type of operation (read/write) is known prior to the execution of an application. This enables the cache line usage for every cache line to be determined prior to the execution of the workload entry.

The cache line information can include a cache line identifier (412). Additionally, the cache line information can include cache line usage data (414). The cache line usage data can indicate a frequency in which the cache line is used during execution of the portion of the application. As an addition or variation, the cache line usage data indicates at least one of a time or interval between when the cache line is utilized during execution of the portion of the application.

Further, in examples, he ECU 200 can implement a cache line replacement policy for executing the portion of the runtime application based on the cache line information (420). In examples, the cache line replacement policy can selectively designate cache lines as priority based on the known usage of the cache line in the upcoming time interval when the corresponding workload is executed.

### CONCLUSION

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

What is claimed is:

1. An electronic control unit (ECU), the ECU comprising:
a plurality of chiplets to perform a plurality of workloads used to control or perform vehicle functions for a vehicle, the vehicle functions including automated driving or driver assistance;
control logic configured to:
determine cache line information for at least a portion of a runtime application in advance of the portion of the runtime application being executed, the cache line information including, for each of one or more cache lines that are to be used in the execution of the portion of the runtime application, each of (i) a cache line identifier, and (ii) corresponding cache line usage that indicates an extent to which the cache line is to be utilized; and
based on the cache line information, implement a cache line replacement policy for executing the plurality of workloads.

2. The ECU of claim 1, wherein the runtime application is statically laid out (SLO), and wherein an execution of the runtime application is implemented through the plurality of workloads, the SLO execution of the runtime application being associated with a computation graph, and wherein the control logic is configured to determine the cache line information based at least in part on the computation graph.

3. The ECU of claim 2, wherein the control logic is configured to determine the cache line usage by processing a computation graph that identifies each operation that is to be performed in executing the portion of the runtime application before the portion of the runtime application is executed.

4. The ECU of claim 1, wherein the corresponding cache line usage of each cache line indicates a frequency in which the cache line is used during execution of the portion of the runtime application.

5. The ECU of claim 1, wherein the corresponding usage data for each cache line indicates at least one of a time or interval between when the cache line is utilized during execution of the portion of the runtime application.

6. The ECU of claim 1, wherein the control logic is further configured to assign a priority designation to individual cache lines that are used in the execution of the portion of the runtime application, and wherein the cache line replacement policy is implemented based at least in part on the priority designation of the individual cache lines.

7. The ECU of claim 6, wherein the control logic is configured to assign the priority to individual cache lines by designating a cache management field that indicates at least one of a high priority designation or a low priority designation, and wherein the cache line replacement policy provides for replacing cache lines with the low priority designation before any cache lines with the high priority designation are replaced.

8. The ECU of claim 1, wherein the control logic schedules a plurality of workloads for execution in a reservation table, each workload of the plurality of workloads being associated with a data structure that identifies a priority designation for one or more cache lines used in executing the workload.

9. The ECU of claim 8, wherein each workload of the plurality of workloads is associated with a type and subtype, based at least in part on a function performed by the workload, and wherein the priority designation for the one or more cache lines is based at least in part on a type and subtype of a corresponding workload entry.

10. A vehicle control unit comprising:
a plurality of chiplets, including a first chaplet, the first chiplet including a main memory and cache resources;
wherein the first chiplet includes control logic that operates on the first chiplet to maintain a reservation table in the main memory, the control logic being configured to identify a plurality of workloads from the execution of the runtime application, each identified workload being associated with a set of cache lines of the cache resource; and
wherein for each identified workload, the control logic determines a priority designation of the set of cache lines based at least in part on a usage of the set of cache lines during an upcoming time interval, the usage being based at least in part on memory access operations that are expected to be performed by the plurality of workloads during the upcoming time interval.

11. The vehicle control unit of claim 10, wherein for each identified workload, the control logic determines the priority designation for the set of cache lines based at least in part on a type or subtype of function performed by the identified workload.

12. The vehicle control unit of claim 10, wherein the usage includes a frequency in which the set of cache lines are accessed in the upcoming time interval.

13. The vehicle control unit of claim 10, wherein the usage includes a time or interval between when cache lines of the set of cache lines are used during the upcoming time interval.

14. The vehicle control unit of claim 10, wherein the control logic implements a cache line replacement policy based on the determined priority designation of the set of cache lines of each identified workload of the plurality of workloads.

15. The vehicle control unit of claim 10, wherein for each identified workload entry, the control logic generates an annotation in the reservation table, the annotation identifying the priority designation for the set of cache lines in the reservation table, in association with the identified workload.

16. A method for managing a cache resource on an electronic control unit (“ECU”), the method comprising:
identifying a plurality of workloads from execution of a runtime application, each identified workload being associated with a set of cache lines of a cache resource; and
determining a priority designation of the set of cache lines based at least in part on a usage of the set of cache lines during an upcoming time interval, the usage being based at least in part on memory access operations that are expected to be performed by the plurality of workloads during the upcoming time interval.

17. The method of claim 16, wherein for each identified workload, the method includes determining the priority designation for the set of cache lines based at least in part on a type or subtype of function performed by the identified workload.

18. The method of claim 16, wherein the usage includes a frequency in which the set of cache lines are accessed in the upcoming time interval.

19. The method of claim 16, wherein the usage includes a time or interval between when cache lines of the set of cache lines are used during the upcoming time interval.

20. The method of claim 16, further comprising implementing a cache line replacement policy based on the determined priority designation of the set of cache lines of each identified workload of the plurality of workloads.
